(19) United States
(12) Patent Application Publication
(10) Pub. No.: US 2002/0173982 A1
(43) Pub. Date: Nov. 21, 2002

(54) Expert system for determining a product or a solution principle for a technical problem

(76) Inventor: Gerhard Drunk, Munchen (DE)

Correspondence Address: SUTHERLAND ASBILL & BRENNAN LLP, 999 PEACHTREE STREET, N.E., ATLANTA, GA, 30309, US

(21) Appl. No.: 09/955,583

(22) Filed: Sep. 18, 2001

(30) Foreign Application Priority Data
Sep. 18, 2000 (DE) 100 46 116.6

(51) Int. Cl. G06F 17/60

(52) U.S. Cl. 705/1

(57) ABSTRACT

Apparatus and method for ascertaining at least one stored product and/or at least one stored solution principle, production and infrastructure planning device, computer-readable storage medium and computer program element

One application from a set of prescribed possible applications is selected. In addition, at least one possible stored requirement parameter from a plurality of requirement parameters associated with the selected application is selected. At least one requirement parameter value is ascertained for the selected requirement parameter. The selected application and the at least one requirement parameter value are taken into account to ascertain at least one product and/or a solution principle stored in a database together with at least one product parameter which is associated with the respective product or a solution parameter which is associated with the respective solution principle and has at least one associated product parameter value or a solution parameter value in each case. The ascertaining is done by comparing the at least one selected requirement parameter value with the stored product parameter value or the stored solution parameter value.

Apparatus and method for ascertaining at least one stored product and/or at least one stored solution principle, production and infrastructure planning device, computer-readable storage medium and computer program element

The invention relates to an apparatus and a method for ascertaining at least one stored product and/or at least one stored solution principle.

If a user looking for a product knows a solution principle to be applied and at least one name for at least one product class operating on the basis of this solution principle, which product class contains at least one product, then apparatuses and methods for ascertaining products on the basis of the selection of a product class and the entry of product parameter values for a set of product parameter values characterizing the product are known for this case.

In the context of this known practice for ascertaining at least one stored product, a set of available and hence selectable products is stored in a database.

The products are respectively associated with a product class, where a product class in this context is to be understood to mean a group of products which act on the basis of the same solution principle and are identified by a shared name.

A product in this context is to be understood to mean a specific product from a supplier having defined product properties, the product parameters. A product is also to be understood in this context to mean a combination of individual components which go together, for example a unit comprising measurement pickup, measurement amplifier, evaluation computer, etc., which achieve the respective objective only collectively.

The individual products thus have associated product specification parameters, also referred to below as product parameters, which characterize the respective product more precisely in terms of its properties and functions. Each product parameter normally has at least one associated product parameter value.

A user of the apparatus can use a search mask to enter search product parameter values, and a comparison between the search product parameter values and the stored product parameter values is used to ascertain whether one or more products have product parameter values which correspond to the search product parameter values with a sufficient degree of accuracy.

If it is possible to ascertain such a product from the stored products, then this product is displayed and made available to the user for possible selection.

However, a prerequisite for using this method and this apparatus is that the user already knows solution principles and product classes suitable for achieving his objective.

In many cases, however, the user does not know which solution principles and hence associated product classes are suitable for achieving his objective, characterized by a required level of functionality. It is normally possible to use different solution principles and product classes to achieve one objective, which solution principles and product classes are normally known to the user only in part or not at all. In this case, the user looks for a way of achieving his objective and not for a specific product.

Whether and to what extent a solution principle and the product classes operating on the basis thereof are suitable for achieving an objective is decided on the basis of scope and of requirement parameter values for an objective's demanded level of functionality. However, an objective's demanded level of functionality and suitability limit values for solution principles and product classes acting on the basis thereof are described by different parameter dimensions. The lack of opportunity to associate requirement parameter space for the functionally described objective and suitability parameter space for the solution principles with associated product classes prevents the use of existing database search functions in this case.

The invention is thus based on the problem of specifying an apparatus and a method for ascertaining a product and/or a solution principle which can be used fittingly even in an instance where the user does not know which solution principles and/or product classes are suitable for achieving his objective.

The problem is solved by the apparatus and the method for ascertaining a product and/or a solution principle, the production and infrastructure planning device, the computer-readable storage medium and the computer program element having the features in accordance with the independent patent claims.

An apparatus for ascertaining at least one stored product and/or a stored solution principle has a processor which is set up such that the method steps described below can be carried out.

In addition, a memory is provided which stores the data required for carrying out the method.

One application from a set of prescribed possible applications is presented to a user for selection and is selected by the user.

A user in this context is to be understood to mean a person who is using the apparatus to ascertain a solution principle and/or a product for achieving his objective.

A solution principle in this context is to be understood to mean a method or a technology, etc., for achieving one or more objectives.

An application in this context is to be understood to mean an objective which is described by a demanded level of functionality.

Each application has at least one respective requirement parameter associated with it which characterizes the respective application.

In a further step, at least one requirement parameter is presented to the user for the selected application, and, on the basis of the respective demanded level of functionality for the selected application which the user wants to achieve, the user enters at least one specific requirement parameter value for the requirement parameter, said requirement parameter value forming a search range for a value interval for the respective requirement parameter.

A parameter value is to be understood in each case to mean, by way of example, a numerical value characterizing the corresponding parameter, a property or a combination of properties.

In addition, the memory in the apparatus stores products (product details) together with product parameters which are associated with the products and at least some of which normally have associated product parameter values.

Alternatively or in addition, the memory in the apparatus stores information about solution principles, referred to below as solution principles, together with solution parameters which are associated with the solution principles and at least some of which normally have associated solution parameter values.

The solution principles are preferably technical solution principles, for example from the field of process technology, production technology or else infrastructure technology.

A product parameter may, by way of example, characterize the product more precisely in terms of its technical properties or else in terms of its technical applicability.

A solution parameter may, by way of example, characterize the solution principle more precisely in terms of its technical properties or else in terms of its technical applicability.

To simplify the search, the suitability of solution principles and/or products for an application may have been identified.

On the basis of the selected application and the at least one requirement parameter value, at least one product and/or a solution principle from the stored set of products and/or from the stored set of solution principles is ascertained. The ascertaining is done by comparing the at least one selected requirement parameter value with the stored product parameter values and/or solution parameter values.

As an alternative to the processor, the apparatus may respectively contain individual units which are respectively set up such that one or more of the method steps described above can be carried out.

The invention may be implemented both using a computer program, i.e. in software, and using a specific electronic circuit, i.e. in hardware.

A computer-readable storage medium stores a computer program for ascertaining at least one stored product and/or at least one stored solution principle which, when executed by a processor, has the method steps described above.

In addition, a computer program element for ascertaining at least one stored product and/or at least one stored solution principle is provided which, when executed by a processor, has the method steps described above.

In addition, a production and infrastructure planning device having an apparatus as described above is provided.

Preferred developments of the invention can be found in the dependent claims.

In accordance with one refinement of the invention, a list of a set of prescribed possible applications, preferably stored in the manner of a thesaurus, is provided which is presented to the user. Any application can be selected from the list

This refinement clearly provides the user with a prescribed headword index for the applications which can be selected, which makes it possible to record the entered information in a prescribed formal data structure.

This refinement of the invention provides a very simple, and hence both inexpensively implementable and user-friendly, way of allowing a user to recognize and select the functional description of his personal objective.

Alternatively, it is likewise possible for the user to use an input mask to enter an objective which he has formulated freely, and for the apparatus to use a parser, for example using a dialog program, to ascertain an application which fits the formulated objective.

In accordance with a further refinement of the invention, the stored product parameters and/or solution parameters and/or requirement parameters are transformed into a prescribed comparison space so that it is possible to compare the stored product parameter and/or solution parameter with the requirement parameter.

This transformation presents a reliable, meaningful and automated opportunity to compare the respective requirement parameter with a product parameter and/or solution parameter.

The comparison space has a number of dimensions which corresponds to the number of requirement parameters, product parameters and solution parameters taken into account, where the number of requirement parameters, product parameters and solution parameters may be different. A differing number of requirement parameters, product parameters and solution parameters is compensated for by the transformation into the comparison space.

The transformed requirement parameter values, transformed product parameter values and transformed solution parameter values respectively represent individual values on the comparison space axis respectively determined by the dimension.

The comparison space may be a space which is defined independently of the spaces respectively defined by the requirement parameters, the product parameters and solution parameters (requirement parameter space, product parameter space and solution parameter space) and into which the requirement parameters, the product parameters and solution parameters are transformed.

Alternatively, however, the comparison space may also be equal

to the product parameter space in which the at least one stored product parameter is described, or

to the solution parameter space in which the at least one stored solution parameter is described, or

to the requirement parameter space in which the at least one stored requirement parameter is described.

In this case, only one parameter transformation is carried out.

If, by way of example, the product parameter space is the comparison space, then the requirement parameters are transformed into the product parameter space, etc.

In accordance with a further refinement of the invention, the stored product parameters, the stored solution parameters and also the requirement parameters respectively contain only parameters from a prescribed, stored set of possible parameters which can be used, which parameters form the comparison space.

The parameter dimensions are transformed from requirement parameters and product parameters into a comparable dimension in the comparison space such that an association is clearly made using metadata with metaparameters identified by logical content and standardization, and by means of rules for converting standardizations.

This allows requirement parameters and product parameters and/or solution parameters to be logically associated with one another and to have their standardizations converted to one another if appropriate.

An example of such a transformation is given below:

| | |
|---|---|
| requirement parameter: | workpiece width in cm; |
| product parameter: | measurement range in m; |
| metaparameter: | distance in X dimension in mm. |

The metadata may also be defined in line with product parameters used as standard.

In this context, the term “parameter” is to be understood to mean a unit of parameter content and standardization, for example the unit to be used for the parameter content for the purposes of entry, for example m, cm, mm, kg, g, W, kW, etc. The standardization ensures that a reliable comparison can be made between the requirement parameter values and the product parameter values or the solution parameter values.

Stipulating clearly one metadata structure containing a set of altogether only permissible parameters that can be used as requirement parameters or product parameters and/or solution parameters to characterize an application and/or a product and/or a solution principle ensures that it is possible to compare the requirement parameter values and the product parameter values and/or the solution parameter values.

In addition, a plurality of requirement parameters can be presented to the user, and a plurality of requirement parameter values can be ascertained. The products and/or solution principles may also have an associated plurality of product parameters with product parameter values and/or solution parameters with solution parameter values. In this case, the comparison may be made such that, if a requirement parameter value is not satisfied by a product or its corresponding product parameter value and/or by a solution principle or its corresponding solution parameter value, the discrepancy between the appropriate requirement parameter value and the product parameter value or solution parameter value is weighted on the basis of a prescribed weighting distribution and then a weighted comparison result is ascertained.

This makes it possible to give the individual factors of influence, i.e. the different requirement parameters and/or the product parameters and/or the solution parameters, different weightings in terms of their significance for an application. This further improves the reliability of the result of ascertainment.

In a further refinement of the invention, those requirement parameters and requirement parameter values which are not or are not adequately satisfied by a respective product or a, preferably technical, solution principle are displayed to the user of the apparatus together with the associated product parameter values or solution parameter values. In addition, the causes of their not being satisfied can likewise be displayed to the user in addition or as an alternative.

One development of the invention also provides for only those products and/or solution principles which have been identified as suitable for the selected application to be taken into account in the comparison.

This development makes it possible to perform the comparison much faster and with less computation, and hence less expensively.

In accordance with a further refinement of the invention, at least one portion of the requirement parameters is grouped into at least one main requirement parameter and at least one subrequirement parameter, and, if the main requirement parameter is selected, at least one subrequirement parameter is selected as the requirement parameter on the basis of the selected main requirement parameter.

This prevents subrequirement parameters not needed in this main requirement from being retrieved.

This refinement also makes it possible to perform the comparison much faster and with less computation, and hence less expensively.

In addition, at least one portion of the requirement parameters may be allocated prescribed cost drivers and limit values for sudden cost changes (cost limit values) based on the requirement parameter values. The cost drivers and/or the limit values are presented to the user to allow him to assess quickly, easily and clearly which requirement parameters have a greater or lesser effect in terms of the costs to be expected when achieving the objective.

This reduces the risk of overspecification by the user and hence increases the likelihood of the search being successful.

In addition, at least one portion of the applications may have one or more associated subapplications which allow the application to be made more flexible and to be selected or described in more detail.

In accordance with this development, one subapplication from a set of prescribed possible subapplications for the selected application is selected, and at least one possible stored requirement parameter from a plurality of requirement parameters associated with the selected application and subapplication is selected, each requirement parameter characterizing the respective application and/or the subapplication. The selected application and the subapplication and the at least one requirement parameter value are taken into account to ascertain at least one product.

In addition, at least

one portion of the requirement parameters, and/or

one portion of the solution parameters, and/or

one portion of the product parameters, and/or

one portion of relationships between at least one requirement parameter and a solution parameter and/or between at least one requirement parameter and a product parameter, and/or

the type of transformation into the comparison space, and/or

at least one portion of the groupings, and/or

at least one portion of the weightings, and/or

at least one portion of the cost drivers and cost limit values may be freely configurable by a user and/or an operator.

Within the context of the invention, free configurability is to be understood within the context of hardware to mean, by way of example, setting switch positions and defining connections between individual circuit components, and within the context of software to mean, by way of example, entering values into a structured parameter mask or using a graphical or textual configuration language for stipulation purposes.

An operator in this context is to be understood to mean a person who makes the apparatus available to the user and programs or configures the way in which the ascertainment works.

This refinement significantly increases the flexibility of the apparatus such that an operator can enter the search algorithms on a user interface which does not require the program code to be altered in any way.

The invention is particularly suitable for use in the field of production automation, process automation or infrastructure automation.

An exemplary embodiment of the invention is shown in the figures and is explained in more detail below.

In the figures,

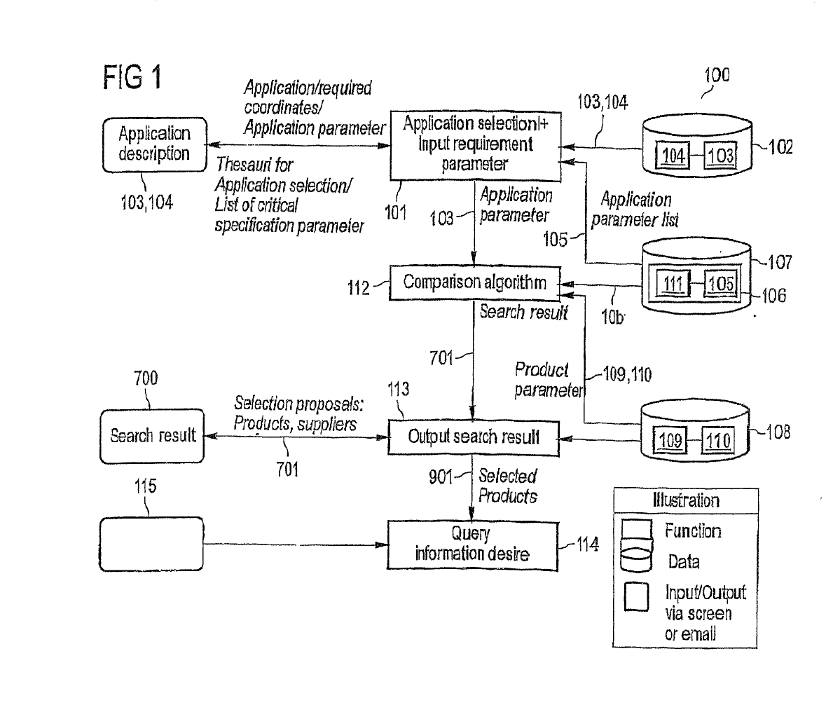

FIG. 1 shows a block diagram showing the individual components of an exemplary embodiment of the invention;

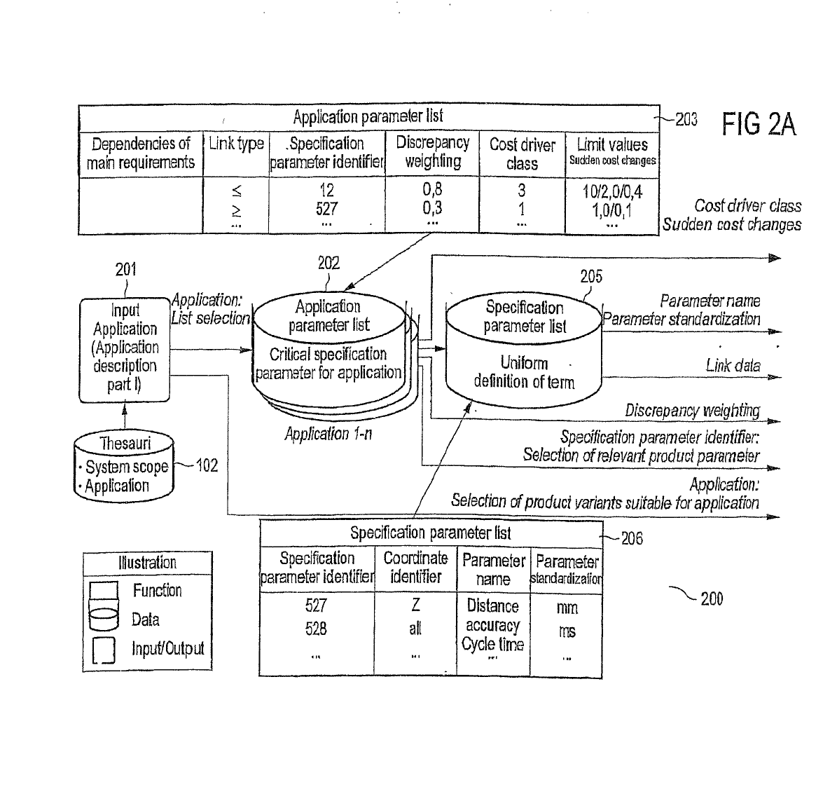

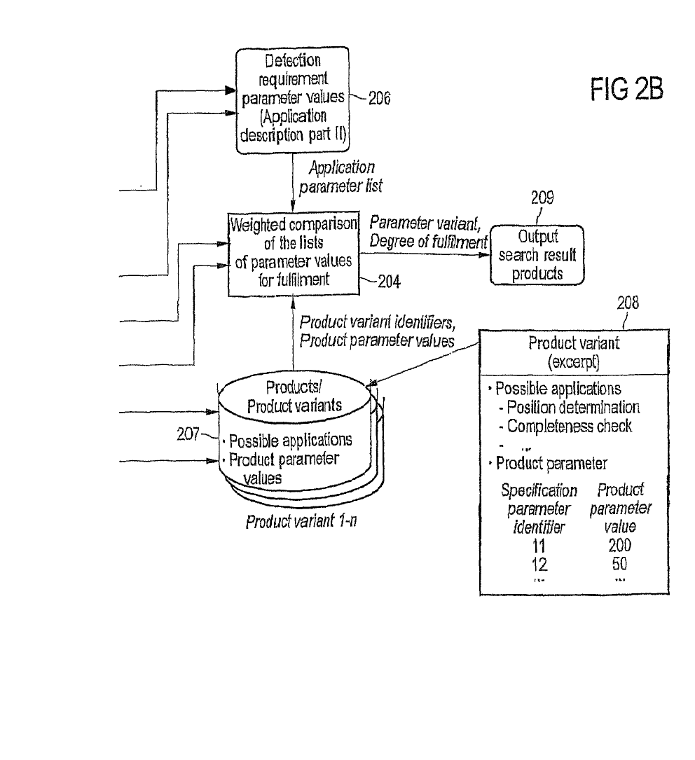

FIG. 2 shows a block diagram showing the procedure for ascertaining a product in accordance with the exemplary embodiment of the invention;

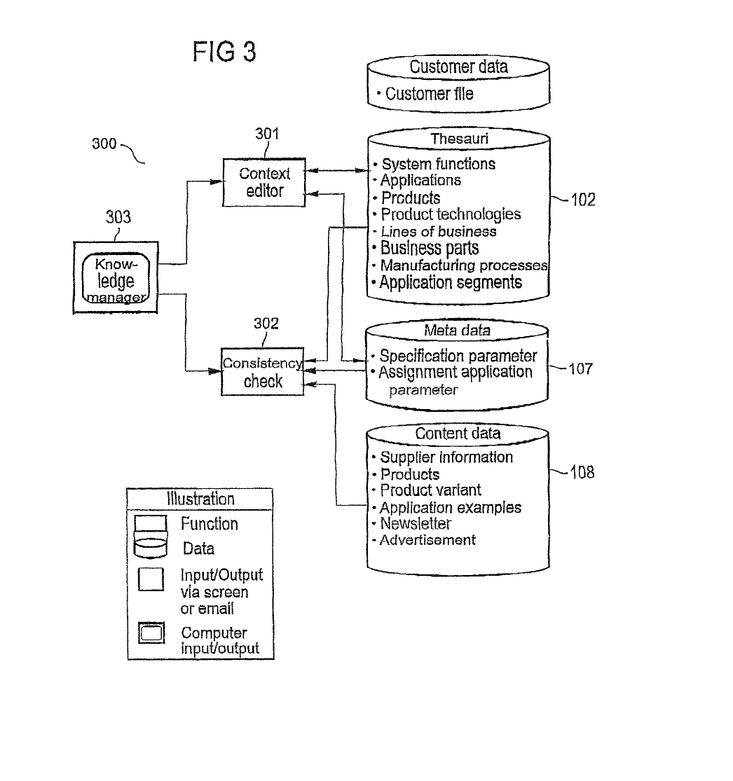

FIG. 3 shows a block diagram showing the procedure for ascertaining a product in accordance with the exemplary embodiment of the invention;

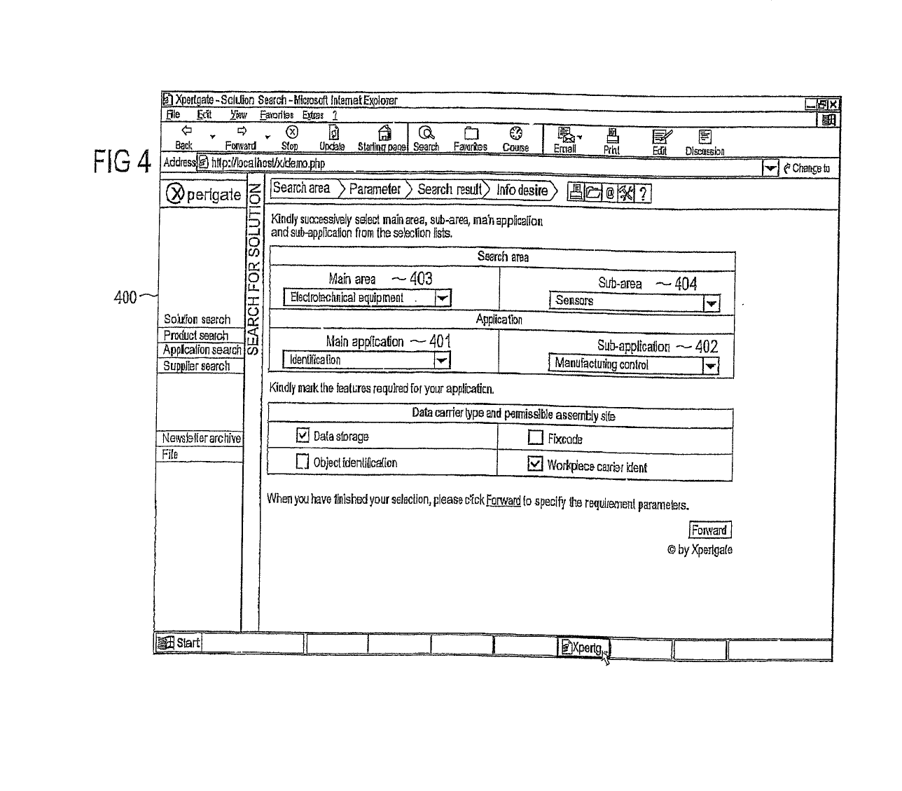

FIG. 4 shows an illustration of a screen mask for entering the application, with selection of the search area, application selection and main requirement parameter selection;

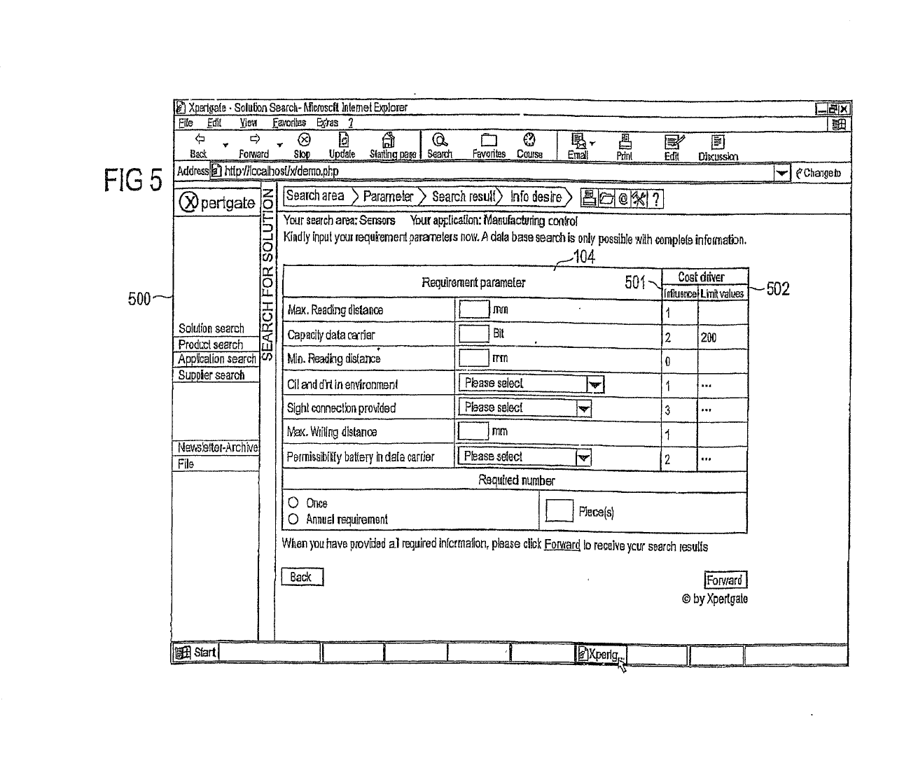

FIG. 5 shows an illustration of a screen mask for entering requirement parameter values;

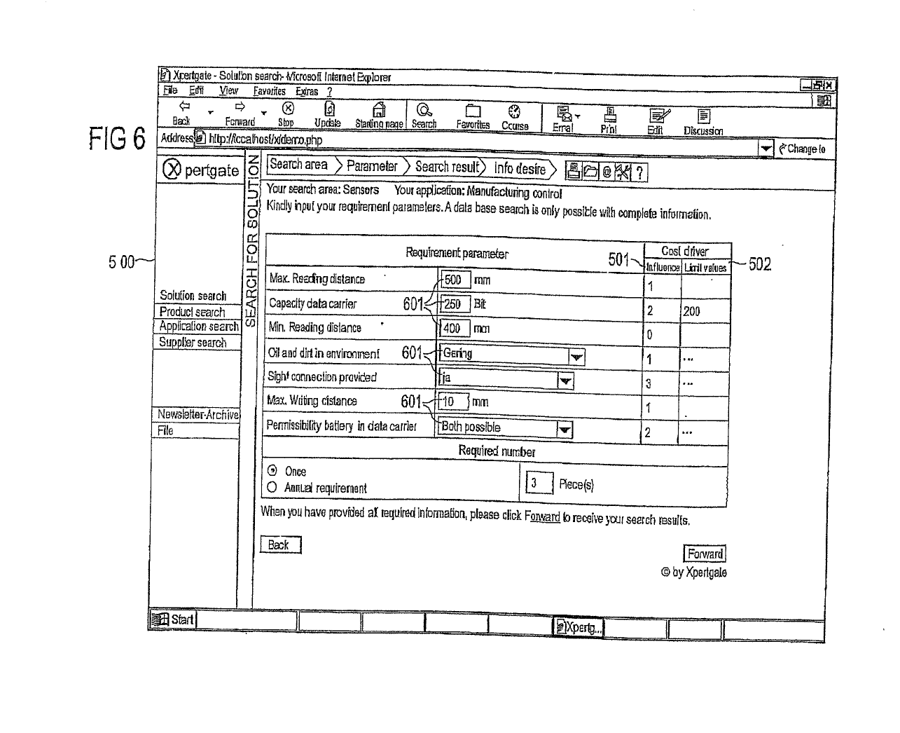

FIG. 6 shows an illustration of a screen mask for entering the requirement parameter values, with a few requirement parameter values having already been entered;

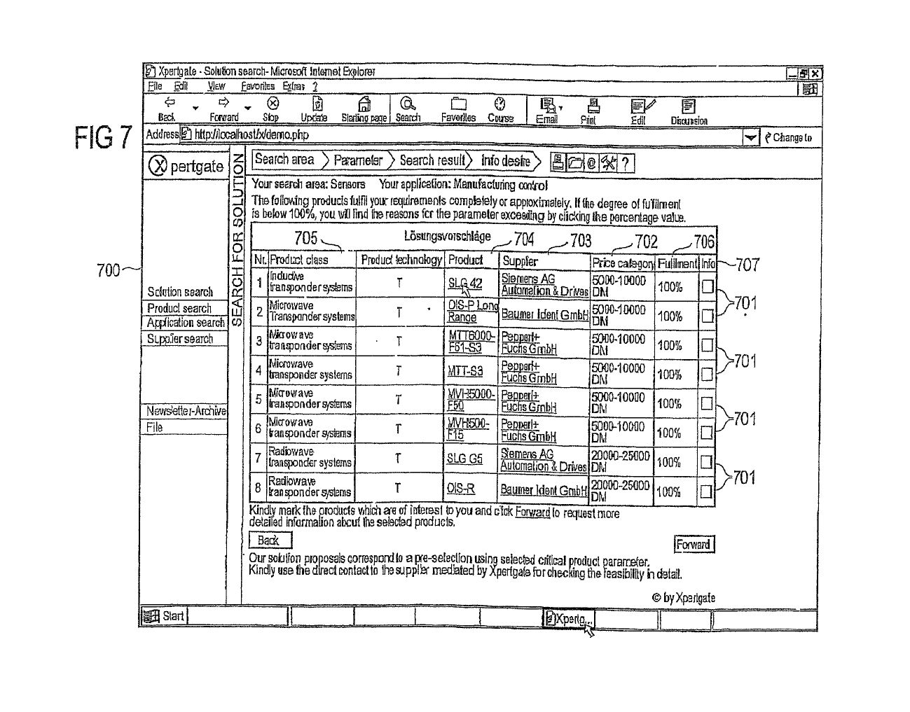

FIG. 7 shows an illustration of a screen mask showing ascertained products, with presentation of the respective solution principles, shown as product class, and the weighted discrepancy (degree of satisfaction);

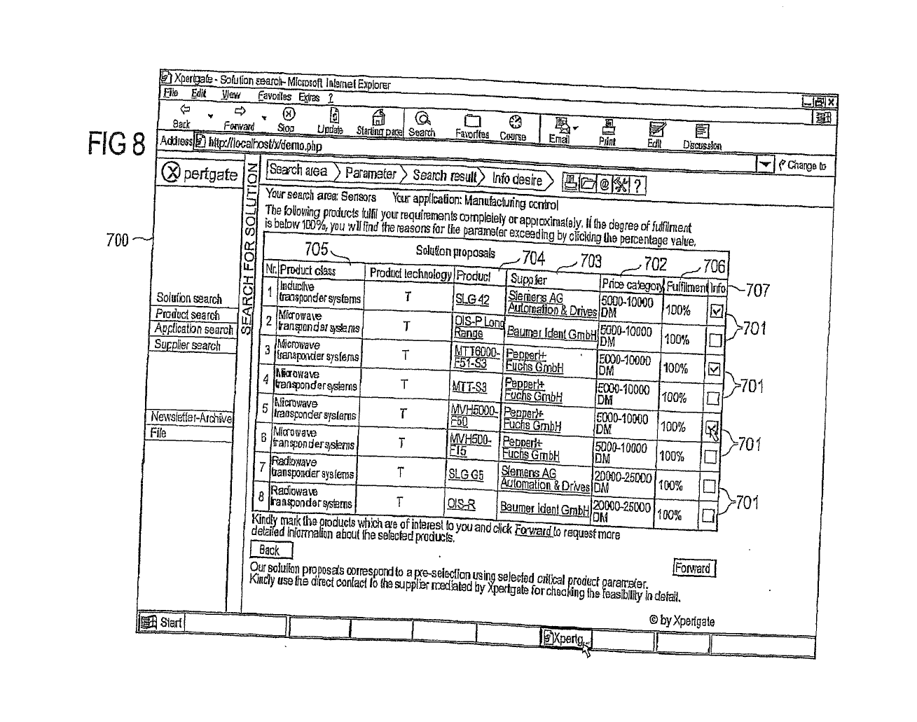

FIG. 8 shows an illustration of a screen mask showing ascertained products, a few products having been selected for the purposes of detailed information presentation;

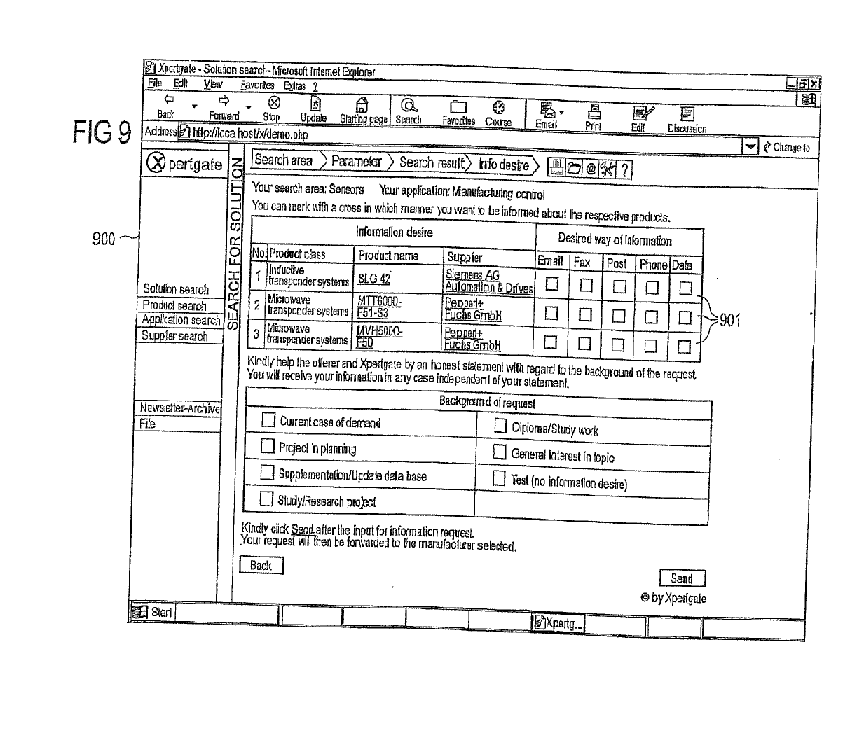

FIG. 9 shows an illustration of a screen mask in which the desired information path can be chosen by the user for the selected products and the query background is entered;

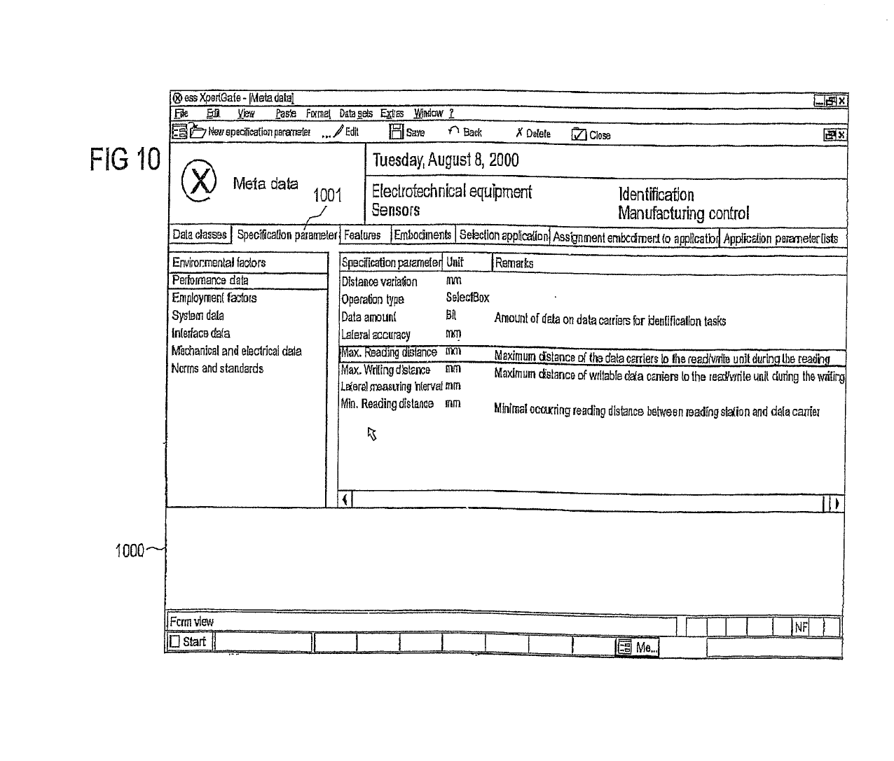

FIG. 10 shows an illustration of a screen mask showing individual metaparameters in the configurator;

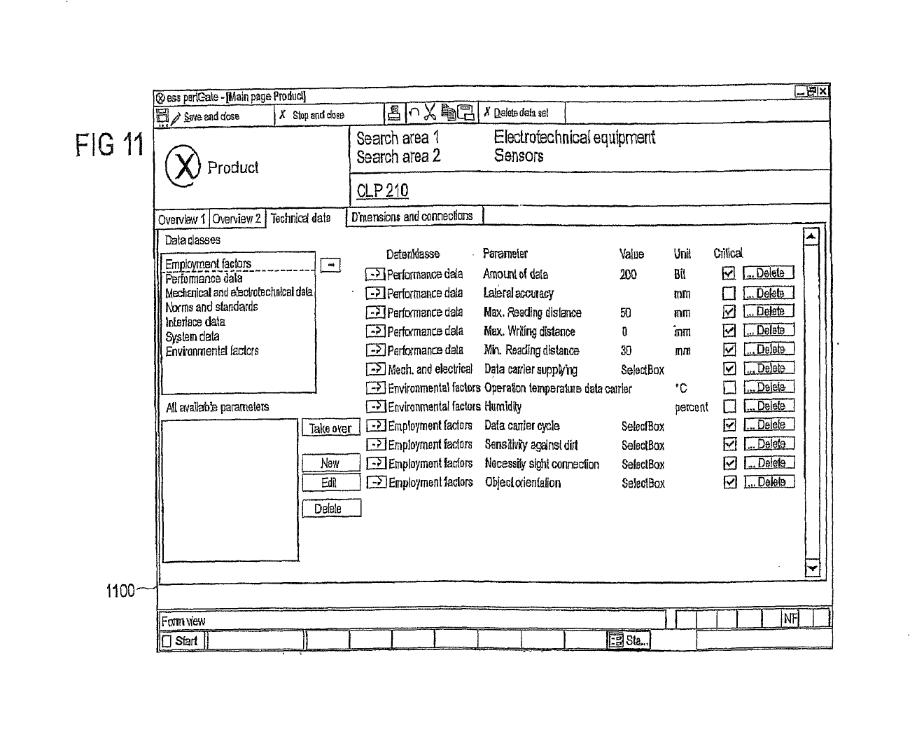

FIG. 11 shows an illustration of a screen mask showing individual product parameters and product parameter values for a stored product;

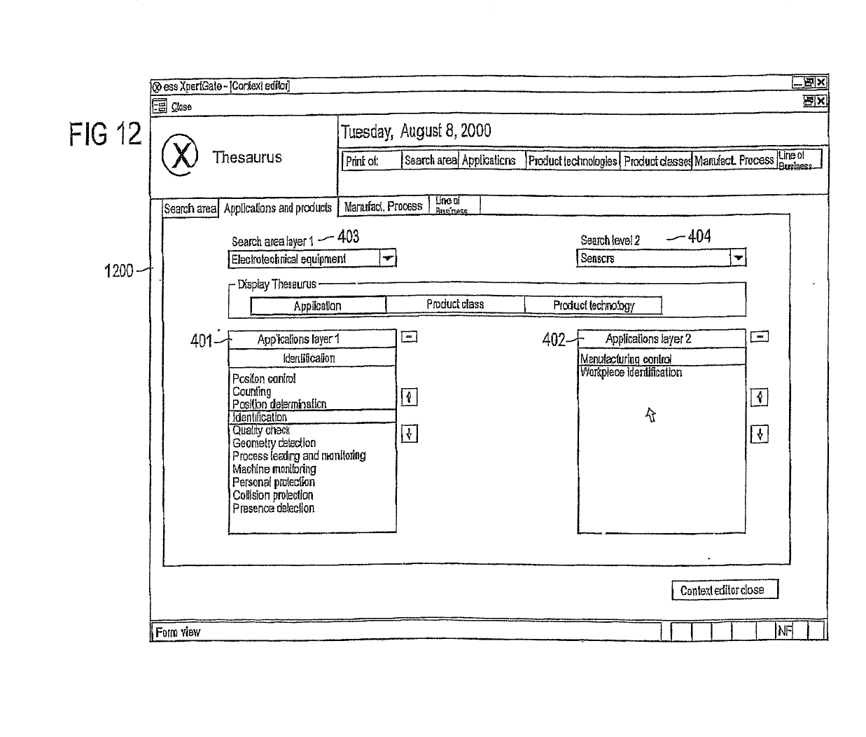

FIG. 12 shows an illustration of a screen mask showing individual relationships between an application and the subapplication associated with the application in the configurator;

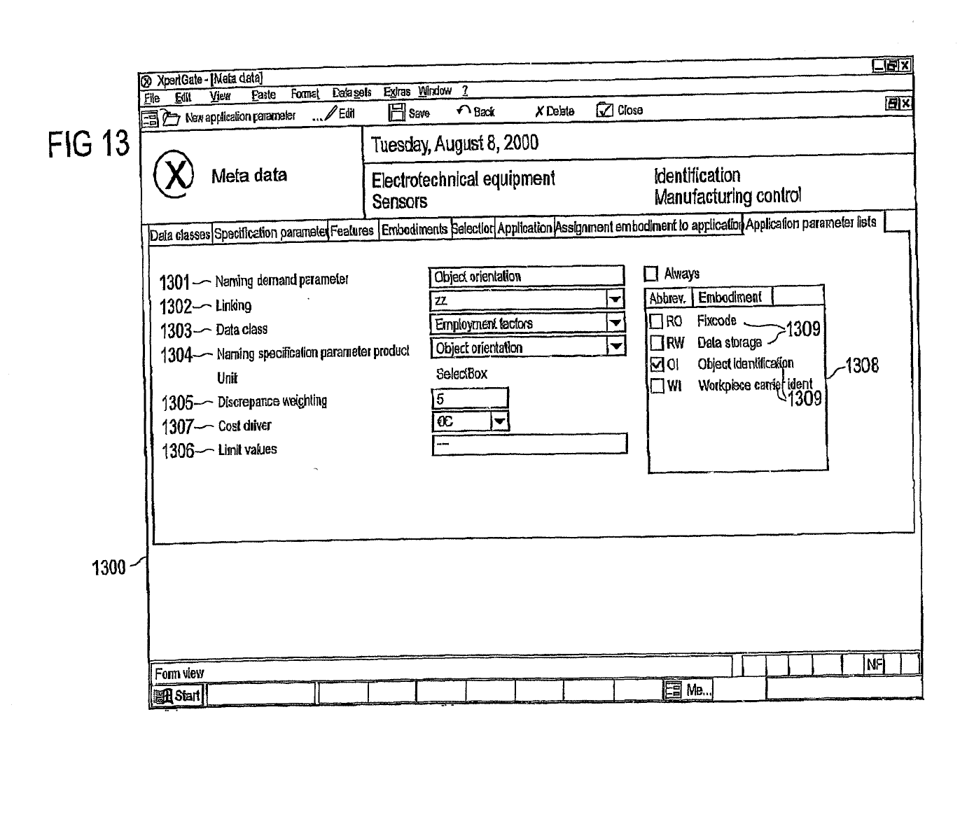

FIG. 13 shows an illustration of a screen mask showing the configuration of one parameter transformation for ascertaining solution principles and/or products in the configurator;

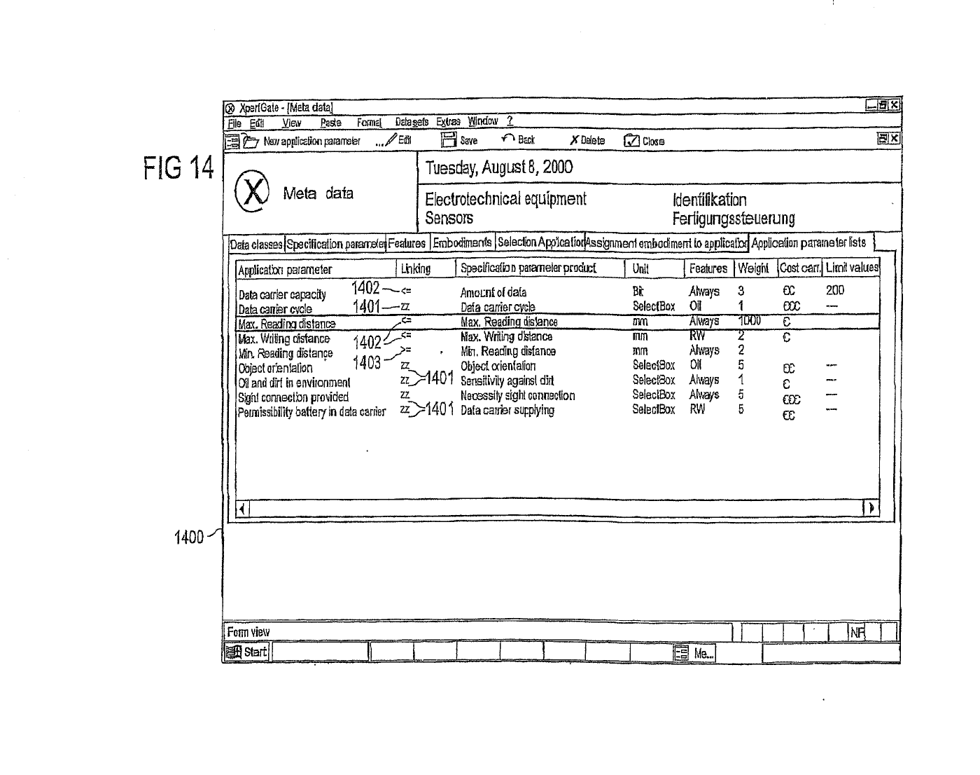

FIG. 14 shows an illustration of a screen mask showing the configuration of all the parameter transformations for ascertaining solution principles and/or products for an application in the configurator;

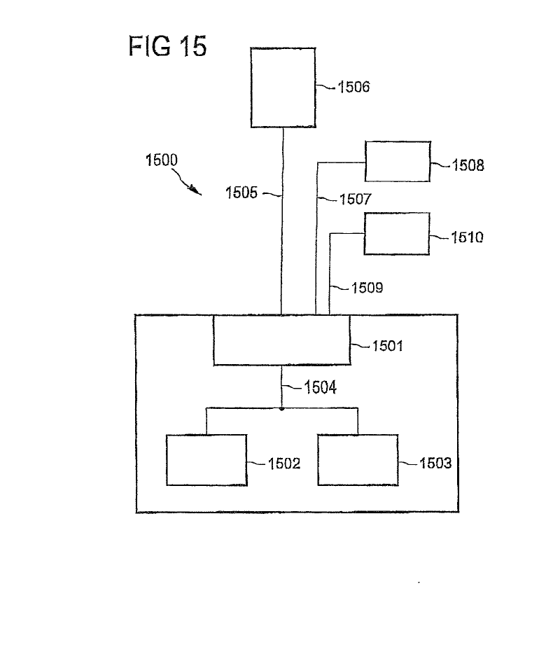

FIG. 15 shows a block diagram of a computer used to carry out the method in accordance with an exemplary embodiment.

FIG. 15 shows a computer 1500

having an input/output interface 1501,

having a processor 1502, and

having a memory 1503,

which are coupled to one another via a computer bus 1504.

The computer 1500 is connected to a screen 1506 by means of a first cable 1505, to a keyboard 1508 by means of a second cable 1507 and to a computer mouse 1510 by means of a third cable 1509.

The memory stores a plurality of databases and a database application program, in this exemplary embodiment Postgres™.

The database data described below are stored and managed, i.e. retrieved, for example, in a respective database using the database application program.

FIG. 1 shows a block diagram 100 which is used to explain the individual logical components of the apparatus.

An application selection unit 101 presents applications 103 stored in a first database 102 and the functional description of said applications and also requirement parameters 104 to a user of the apparatus on the screen 1506.

An application in this context is to be understood to mean a, preferably technical, objective for which a solution needs to be ascertained in the form of a solution principle proposal and/or product proposal for products which, on the basis of the objective, appear to be suitable for solving this problem.

In the field of production automation, the following technical objectives are provided as the main application 401 in this exemplary embodiment (cf. screen mask 400 in FIG. 4 and screen mask 1200 in FIG. 12):

position control for a workpiece (1201),

“counting” function,

a position finding for a workpiece,

identification of a workpiece,

quality testing for a workpiece,

geometric measurement for a workpiece,

process management and monitoring,

machine monitoring,

personal protection,

collision prevention,

detection of presence.

On a general basis, each technical objective can be prescribed as an application, according to the required area of use.

In addition, at least some of the individual main applications 401 always have associated subapplications 402; in this exemplary embodiment, the main application “identification of a workpiece” has the associated subapplications:

production control, and

tool identification.

The main applications 401 and/or the subapplications 402 have associated requirement parameters. The permissible requirement parameters 105 may be allocated to a main application 401 and/or to a subapplication 402. The permissible requirement parameters 105 are stored in a formal prescribed data structure as metadata 106 in a second database 107.

Only requirement parameters which are stored in the list of permissible requirement parameters 105 as part of the metadata 106 may be defined and allocated to the main applications 401 and/or to the subapplications 402.

In addition, the search criteria made available to the user for selection are a technical main area 403 and at least one technical subarea 404 for the respective technical main area 403, as a localization ahead of application selection.

Examples of possible technical main areas 403 are:

electrotechnical equipment,

mechanical equipment,

software systems,

services.

Examples of possible technical subareas 404 of the technical main area 403 “Electrotechnical equipment” are:

sensors,

controllers,

devices for operation and observation,

bus systems,

drives,

etc.

In addition, a third database 108 stores product details for a product with the product parameters 110 and product parameter values 109 associated with the products.

The permissible product parameters 111 which can be allocated to a product are likewise stored as metadata 106 in a formal prescribed data structure in the second database 107.

FIG. 10 shows a screen mask 1000 defining, in the configurator, the metaparameters which are in turn concurrent with the permissible product parameters 1001.

In accordance with this exemplary embodiment, the metaparameters relating to data classes are grouped into a prescribable number of hierarchical levels.

In addition, FIG. 11 shows a further screen mask 1100 showing the technical data associated with the respective product in the form of product parameters and product parameter values.

In accordance with this exemplary embodiment, the individual products are associated with prescribed product classes.

Only product parameters 110 which are stored in the list of permissible metadata 106 can be defined and allocated to the main applications 401 and/or to the subapplications 402.

In addition, the individual product parameters 110 are allocated product parameter values characterizing the respective products more precisely in terms of their properties.

If the user respectively selects a main application 401, a subapplication 402, a technical main area 403 and a technical subarea 404, then, after the selected data have been entered as appropriate, the user is presented with a further screen mask 500, as shown in FIG. 5, which lists requirement parameters 103 associated with the corresponding application (selected main application 401 and subapplication 402).

As FIG. 4 shows, a few requirement parameters are already being presented and made available to the user for a preselection of requirement parameters together with the main applications, the subapplications, the technical main areas and the technical subareas.

These requirement parameters made available for preselection are referred to below as main requirement parameters 405.

In accordance with this exemplary embodiment, the following main requirement parameters 405 are provided:

data store,

object identification,

permanent code,

workpiece holder ID.

In accordance with this exemplary embodiment, the further requirement parameters 104 are also selected on the basis of the selected main requirement parameters 405.

The user is asked to allocate requirement parameter values to at least one portion of the requirement parameters 104. The requirement parameters 104 have been individually matched to the corresponding applications and are associated therewith.

The individual requirement parameters 104 are given different weightings in terms of their significance for the respective application using different weight factors 501, 1305 if the respective requirement parameter value is not satisfied by the appropriate product parameter value and/or solution parameter value.

In addition, a few requirement parameters 104 have associated cost drivers and limit values 502 for costly sudden changes in technology for the possible requirement parameter values, in order to prevent overspecification by the user to a large extent. This substantially increases the likelihood of hits for the search, and the costs of the solutions ascertained are reduced.

FIG. 6 shows the screen mask 500 after a few requirement parameter values 601 have been entered by the user. A requirement parameter value 601 may be a numerical value, a numerical interval, a selection field or else a voice instruction.

Once the requirement parameter values 601 have been entered, a comparison procedure is carried out (block 112), within the context of which the respective product parameter values for all the stored products are compared with the entered requirement parameter values 601 in the transformed form, prescribed by the metadata 106, in the comparison space.

Within the context of the comparison algorithm, the products which are selected and presented to the user, using a screen mask 700 shown in FIG. 7, as suitable products 701 for achieving the specified application (block 113) are those whose product parameter values satisfy the transformed requirement parameter values fully or in part.

For each suitable product 701 displayed, a price class indication 702, the supplier 703 and the name 704 of the respective suitable product, the product classes 705 corresponding to the solution principles and the degree of satisfaction 706, i.e. the correspondence between the respective product parameter values and the entered requirement parameter values, are also displayed.

In addition, an information field 707 is displayed for each suitable product 701 such that it can be selected.

By clicking on the respective information field 707, the user selects those suitable products 701 which are of more interest to him (cf. FIG. 8).

Once products have been selected from the suitable products 701, the selected products 901 are presented to the user (block 114) in a further screen mask 900 (cf. FIG. 9), and the user has the opportunity to select which medium he would like to use to receive the detailed information, for example by email, by fax, by post, by telephone or by means of a personal discussion at a time which is yet to be arranged.

Once the media selection 115 has been entered, the detailed information required is transferred to the user using the selected medium.

It should be noted that the individual databases may naturally also be combined in one database.

FIG. 13 shows a screen mask 1300 which the operator can use to define, i.e. to configure, the transformation of a requirement parameter 1301 himself.

The requirement parameters 104 are thus clearly defined, and hence configured, by the operator using their name 1301 and their relationship or transformation 1302 (link type 1302) with/to the stipulated metadata 106, 1304.

In accordance with this exemplary embodiment, the metaparameters 1304 are concurrent with the permissible product parameters 111.

The requirement parameters 1301 can thus be allocated a link type 1302, i.e. a relationship with a product parameter.

The relationship 1302 used in accordance with this exemplary embodiment is (cf. screen mask 1400 in FIG. 14):

an identity relationship 1401, and/or

a less than or equal to relationship 1402, and/or

a greater than or equal to relationship 1403, and/or

a selection list stipulating the respective permissible states such that they can be selected.

In addition, the requirement parameter 1301 with a freely chosen name is allocated to a data class 1303 and to a metaparameter 1304, in this case identical to the permissible product parameters 105 as metadata 106.

It is also necessary to specify a weighting factor 1305 used to indicate the weighting level to be given to a discrepancy between the requirement parameter value and the product parameter which is to be compared. In addition, a cost driver class 1307 and limit values 1306 for costly sudden changes in technology can be indicated.

The selection field 1308 may also be used to group requirement parameters as subrequirement parameters for main requirement parameters 1309.

This permits a very simple and reliable comparison between the entered requirement parameter values and the product parameter values.

Configuration of the ascertainment is shown in FIG. 10 with the entry of metaparameters, in FIG. 12 with the entry of possible applications 401 and subapplications 402, in FIG. 13 with the entry of individual parameter transformations and in FIG. 14 with the overall presentation of a transformation between the parameter spaces for requirement parameters and product parameters with reference to an application.

In this context, it should be pointed out that the free configurability of the respective relationships and of the parameters is not limited to ascertaining a solution principle and/or a product on the basis of the stipulation of an application.

The free configurability may also be readily used very advantageously when the solution principle or a product class is already known and is entered as a stipulation for ascertaining suitable products.

Such an apparatus for ascertaining at least one stored product when a solution principle or a product class is stipulated has, in particular, a processor which is set up such that the method steps below can be carried out, and also a memory which can store the data required for carrying out the method.

Products stored in a database have associated product parameters. The product parameters in turn have associated product parameter values characterizing the respective product more precisely.

In addition, possible search product parameters, i.e. those made available for selection, are stored. When one or more search product parameters are selected and individual search product parameter values are indicated, the entered search product parameter values are compared with the stored product parameter values in order to ascertain the appropriate product or products which satisfies or satisfy the search requirements.

In this case, the configuration of the individual relationships between the respective search product parameters and the product parameters is likewise freely configurable in a similar manner, described above.

The block diagram 200 shown in FIG. 2 is used to explain the individual steps of the method once again in detail.

The stored applications 103 from the first database 102 are presented to the user for selection.

Once the required application has been selected, i.e. entered (block 201), the application's associated set, i.e. a list 203, of requirement parameters 202 is presented for the application, as shown in detail in FIG. 14, for example.

In accordance with this exemplary embodiment, the application parameter list 203 contains:

a name for the requirement parameter,

an indication of the respective link type,

a product parameter identifier, including standardization, to which the requirement parameter can be linked,

dependency of the requirement parameter as subrequirement parameter on a respective main requirement parameter,

a discrepancy weighting,

an indication of the cost driver class, and

details of limit values and sudden cost changes.

Once one or more requirement parameter values have been entered for the indicated requirement parameters 202 (block 206), a weighted comparison is carried out (block 204) using all the appropriate product parameter values for stored products 207 with optional product variants 208 on the basis of the prescribed links between the requirement parameters and the product parameters 205 from a product parameter list 206.

The comparison result is cutput in the form of a list of suitable products (block 209).

The block diagram 300 in FIG. 3 shows that a context editor 301 and a consistency checking unit 302 are used, under the control of a central control unit 303, to the effect that, when a new requirement parameter or a new product parameter is defined, only permissible requirement parameters or permissible product parameters stored as metadata in the second database 107 are actually used, which ensures the reliability of the comparisons to be carried out.

What is claimed is:

1. An apparatus for ascertaining at least one stored product and/or at least one stored solution principle, having a processor which is set up such that the method steps below can be carried out and having a memory which can store the data required for carrying out the method:
one application from a set of prescribed possible applications is selected,
at least one possible stored requirement parameter from a plurality of requirement parameters associated with the selected application is selected, each requirement parameter characterizing the respective application,
at least one requirement parameter value is ascertained for the selected requirement parameter,
the selected application and the at least one requirement parameter value are taken into account to ascertain at least one product stored in a database together with at least one product parameter which is associated with the respective product and has at least one associated product parameter value in each case, and/or
the selected application and the at least one requirement parameter value are taken into account to ascertain at least one solution principle stored in a database together with at least one solution parameter which is associated with the respective solution principle and has at least one associated solution parameter value in each case,
where the ascertaining is done by comparing the at least one selected requirement parameter value with the stored product parameter value and/or the stored solution parameter value.

2. The apparatus as claimed in claim 1, in which the processor is set up such that a list of a set of prescribed possible applications is presented and any application can be selected from the list.

3. The apparatus as claimed in claim 1 or 2, in which the processor is set up such that the stored product parameters and/or solution parameters and/or the requirement parameter are transformed into a prescribed comparison space such that it is possible to compare the stored product parameter and/or solution parameter with the requirement parameter.

4. The apparatus as claimed in claim 3, in which the processor is set up such that the comparison space is equal
to a product parameter space in which the at least one stored product parameter is described, or
to a solution parameter space in which the at least one stored solution parameter is described, or
to a requirement parameter space in which the at least one stored requirement parameter is described.

5. The apparatus as claimed in claim 3 or 4, in which the processor is set up such that both the stored product parameters and/or solution parameters and the requirement parameters respectively contain only parameters from a prescribed, stored set of possible parameters which can be used, which parameters form the comparison space.

6. The apparatus as claimed in one of claims 1 to 5, in which the processor is set up such that
a plurality of requirement parameters are selected and a plurality of requirement parameter values are ascertained,
a plurality of product parameters and product parameter values are associated with the products, and/or
a plurality of solution parameters and solution parameter values are associated with the solution principles,
the comparison is made such that, if a requirement parameter value is not satisfied, the discrepancy between the appropriate requirement parameter value and the product parameter value and/or solution parameter value is weighted on the basis of a prescribed weighting distribution, and
a weighted comparison result is ascertained.

7. The apparatus as claimed in one of claims 1 to 6, in which the processor is set up such that
one subapplication from a set of prescribed possible subapplications for the selected application is selected,
at least one possible stored requirement parameter from a plurality of requirement parameters associated with the selected application and subapplication is selected, each requirement parameter characterizing the respective application and subapplication,
the selected application and the subapplication and the at least one requirement parameter value are taken into account to ascertain at least one product stored in a database together with at least one product parameter and product parameter value associated with the respective product, and/or
the selected application and the subapplication and the at least one requirement parameter value are taken into account to ascertain at least one solution principle stored in a database together with at least one solution parameter and solution parameter value associated with the respective solution principle,
where the ascertaining is done by comparing the at least one selected requirement parameter value with the stored product parameter value and/or with the stored solution parameter value.

8. The apparatus as claimed in one of claims 1 to 7, in which the processor is set up such that only those products and/or solution principles which have been identified as suitable for the selected application are taken into account in the comparison.

9. The apparatus as claimed in one of claims 1 to 8, in which the processor is set up such that
at least one portion of the requirement parameters is grouped into at least one main requirement parameter and, in each case, at least one subrequirement parameter associated with the main requirement parameter,
if the main requirement parameter is selected, at least one subrequirement parameter associated with the main requirement parameter is selected as the requirement parameter on the basis of the selected main requirement parameter.

10. The apparatus as claimed in one of claims 1 to 9, in which the processor is set up such that at least
one portion of the requirement parameters, and/or
one portion of the solution parameters, and/or
one portion of the product parameters, and/or
one portion of relationships between at least one requirement parameter and a solution parameter and/or between at least one requirement parameter and a product parameter can be freely configured by a user and/or an operator.

11. The apparatus as claimed in one of claims 3 to 10, in which the processor is set up such that the type of transformation into the comparison space can be freely configured by a user and/or an operator.

12. The apparatus as claimed in claim 9 or 11, in which the processor is set up such that at least one portion of the groupings can be freely configured by a user and/or an operator.

13. The apparatus as claimed in one of claims 1 to 12, used in one of the following areas:
production technology, or
process technology, or
infrastructure technology.

14. A production and infrastructure planning device having an apparatus as claimed in one of the preceding claims.

15. A method for computer-assisted ascertainment of at least one stored product and/or of at least one stored solution principle,
in which one application from a set of prescribed possible applications is selected,
in which at least one possible stored requirement parameter from a plurality of requirement parameters associated with the selected application is selected, each requirement parameter characterizing the respective application,
in which at least one requirement parameter value is ascertained for the selected requirement parameter,
in which the selected application and the at least one requirement parameter value are taken into account to ascertain at least one product stored in a database together with at least one product parameter which is associated with the respective product and has at least one associated product parameter value in each case, and/or
the selected application and the at least one requirement parameter value are taken into account to ascertain at least one solution principle stored in a database together with at least one solution parameter which is associated with the respective solution principle and has at least one associated solution parameter value in each case,
where the ascertaining is done by comparing the at least one selected requirement parameter value with the stored product parameter value and/or the stored solution parameter value.

16. A computer-readable storage medium storing a computer program for ascertaining at least one stored product and/or at least one stored solution principle which, when executed by a processor, has the following method steps:
one application from a set of prescribed possible applications is selected,
at least one possible stored requirement parameter from a plurality of requirement parameters associated with the selected application is selected, each requirement parameter characterizing the respective application,
at least one requirement parameter value is ascertained for the selected requirement parameter,
the selected application and the at least one requirement parameter value are taken into account to ascertain at least one product stored in a database together with at least one product parameter which is associated with the respective product and has at least one associated product parameter value in each case, and/or
the selected application and the at least one requirement parameter value are taken into account to ascertain at least one solution principle stored in a database together with at least one solution parameter which is associated with the respective solution principle and has at least one associated solution parameter value in each case,
where the ascertaining is done by comparing the at least one selected requirement parameter value with the stored product parameter value and/or the stored solution parameter value.

17. A computer program element for ascertaining at least one stored product and/or at least one stored solution principle which, when executed by a processor, has the following method steps:
one application from a set of prescribed possible applications is selected,
at least one possible stored requirement parameter from a plurality of requirement parameters associated with the selected application is selected, each requirement parameter characterizing the respective application,
at least one requirement parameter value is ascertained for the selected requirement parameter,
the selected application and the at least one requirement parameter value are taken into account to ascertain at least one product stored in a database together with at least one product parameter which is associated with the respective product and has at least one associated product parameter value in each case, and/or
the selected application and the at least one requirement parameter value are taken into account to ascertain at least one solution principle stored in a database together with at least one solution parameter which is associated with the respective solution principle and has at least one associated solution parameter value in each case,
where the ascertaining is done by comparing the at least one selected requirement parameter value with the stored product parameter value and/or the stored solution parameter value.
